(19) United States
(12) Patent Application Publication
(10) Pub. No.: US 2025/0219543 A1
(43) Pub. Date: Jul. 3, 2025

(54) CONTROL CIRCUIT AND SWITCHING POWER SUPPLY THEREOF

(71) Applicant: Silergy Semiconductor Technology (Hangzhou) LTD, Hangzhou, Zhejiang Province (CN)

(72) Inventors: Shenhua Zhang, Hangzhou (CN); Sheng-Fu Hsiao, Kaohsiung City (TW)

(21) Appl. No.: 18/999,123

(22) Filed: Dec. 23, 2024

(30) Foreign Application Priority Data
Dec. 28, 2023 (CN) 202311845820.6
Dec. 12, 2024 (CN) 202411839512.7

(51) Int. Cl. H02M 3/158; H02M 1/00

(52) U.S. Cl. CPC H02M 3/1584; H02M 1/0025

(57) ABSTRACT

A control circuit for a switching power supply with adaptive voltage positioning control, can include: a compensation signal generation circuit configured to receive a digital voltage reference signal, a digital voltage sampling signal representing an output voltage of the switching power supply, and a digital droop voltage, and to integrate an error between the digital voltage reference signal and a sum of the digital voltage sampling signal and the digital droop voltage, in order to generate a compensation signal; and an adaptive voltage positioning control circuit configured to generate a positioning signal according to the compensation signal, in order to adjust the output voltage.

### RELATED APPLICATIONS

This application claims the benefit of Chinese Patent Application No. 202311845820.6, filed on Dec. 28, 2023, and also claims the benefit of Chinese Patent Application No. 202411839512.7, filed on Dec. 12, 2024, both of which are incorporated herein by reference in their entirety.

### FIELD OF THE INVENTION

The present invention generally relates to the field of power electronics technology, and more particularly to control circuits and associated switching power supplies.

### BACKGROUND

A switched-mode power supply (SMPS), or a “switching” power supply, can include a power stage circuit and a control circuit. When there is an input voltage, the control circuit can consider internal parameters and external load changes, and may regulate the on/off times of the switch system in the power stage circuit. Switching power supplies have a wide variety of applications in modern electronics. For example, switching power supplies can be used to drive light-emitting diode (LED) loads.

### BRIEF DESCRIPTION OF THE DRAWINGS

FIG. 1 is a waveform diagram of an example switching power supply with AVP control.

FIG. 2 is a waveform diagram of an example transient response of the switching power supply with and without AVP control.

FIG. 3 is a schematic block diagram of a first example switching power supply with AVP control, in accordance with embodiments of the present invention.

FIG. 4 is a waveform diagram of the example switching power supply, in accordance with embodiments of the present invention.

FIG. 5 is a schematic block diagram of a second example switching power supply with AVP control, in accordance with embodiments of the present invention.

FIG. 6 is a schematic block diagram of a third example switching power supply with AVP control, in accordance with embodiments of the present invention.

FIG. 7 is a schematic block diagram of a fourth example switching power supply with AVP control, in accordance with embodiments of the present invention.

FIG. 8 is a schematic block diagram of a fifth example switching power supply with AVP control, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

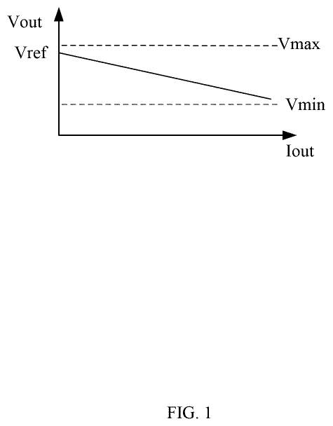

In high-current switching power supplies used in laptops, desktops, servers, and telecommunications equipment, adaptive voltage position (AVP) control is widely used to improve the transient response capability of the system and reduce load power consumption. Referring now to FIG. 1, shown is the basic principle of the AVP control, where Vout represents the output voltage of the switching power supply, Iout represents the output current of the switching power supply, and Vref represents the reference voltage. When output current Iout increases, output voltage Vout decreases within range Vmax-Vmin of the voltage tolerance, where Vmax represents the allowed maximum output voltage value and Vmin represents the allowed minimum output voltage value.

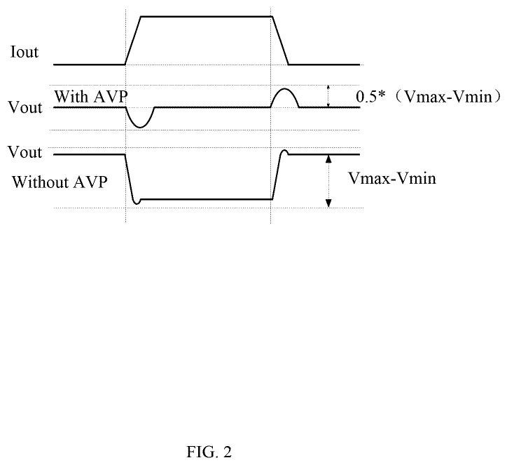

In FIG. 2, the transient response of the switching power supply with and without AVP control is shown. For a switching power supply that does not use AVP control, since output voltage Vout overshoots or undershoots when the load changes, only half of the range of the voltage tolerance may be available. For the switching power supply that is controlled by AVP, output voltage Vout may be adjusted to be slightly higher than minimum value Vmin at full load, and adjusted to slightly lower than maximum value Vmax at light load. Therefore, the range of the voltage tolerance can be available during load transitions, allowing the switching power supply to use smaller output capacitors. In addition, since output voltage Vout decreases when output current Iout increases, the output power of the switching power supply may decrease at full load, which can reduce the difficulty of thermal design. However, with the rapid development of electronic devices, the power of switching power supplies continues to increase. Within the range of the voltage tolerance, traditional AVP control may no longer guarantee the safety, accurate operation, and fast transient response capability of the system.

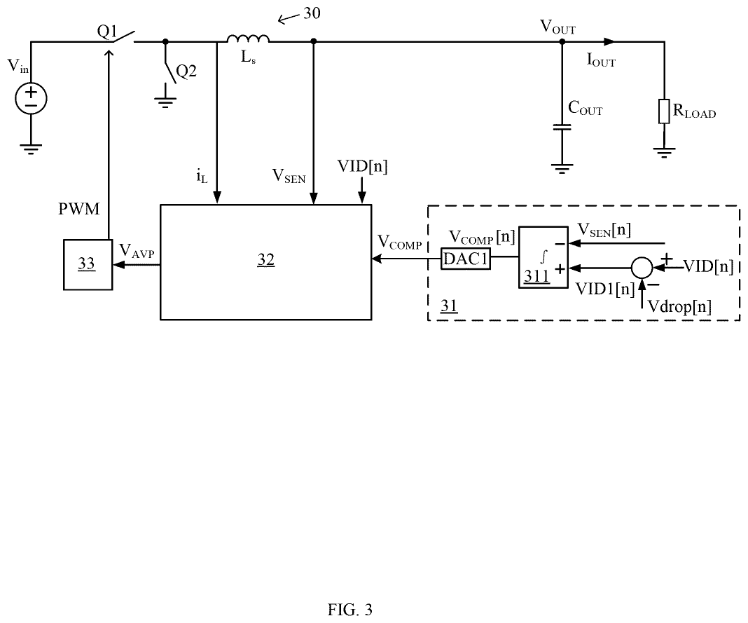

Referring now to FIG. 3, shown is a schematic block diagram of a first example switching power supply with AVP control, in accordance with embodiments of the present invention. In this particular example, the power stage circuit of the switching power supply with AVP control is a buck converter topology; however, any suitable converter topology may be utilized. In this example, power stage circuit 30 can include power transistors Q1 and Q2, and inductor Lₛ can connect between the common node of power transistors Q1 and Q2 and the output terminal of the switching power supply. Optionally, power stage circuit 30 can include output filter capacitor C_{OUT}. The power stage circuit may receive input voltage Vin, and generate output voltage V_{OUT} and output current I_{OUT} after power conversion.

In particular embodiments, the switching power supply can include a control circuit for controlling power stage circuit 30 to achieve power conversion. The control circuit can include compensation signal generation circuit 31 and adaptation voltage positioning control circuit 32. Compensation signal generation circuit 31 can be implemented by a digital circuit to process digital signals, and adaptation voltage positioning control circuit may be implemented by an analog circuit to process analog signals. In this example, compensation signal generation 31 may receive digital voltage reference signal VID[n], digital voltage sampling signal V_{SEN[n]} characterizing the output voltage of the switching power supply, and digital droop voltage Vdrop[n], can integrate the error between the sum of digital voltage reference signal VID[n], and digital voltage sampling signal V_{SEN[n]}, and digital droop voltage Vdrop[n], in order to generate compensation signal VCOMP. Digital voltage reference signal VID[n] may be a digital signal used to characterize an expected output voltage. Digital voltage sampling signal V_{SEN[n]} can characterize the digital signal of the output voltage of the switching power supply, and digital droop voltage Vdrop[n] can characterize the digital signal of the voltage across the droop resistor in the switching power supply. In some cases, designers can set the voltage reference signal and the resistance value of the droop resistor.

In compensation signal generation circuit 31, the control circuit can convert the voltage reference signal characterizing an expected output voltage, and the resistance value of the digital droop resistor (e.g., the voltage across the digital droop resistor), into digital signals. Adaptation voltage positioning control circuit 32 may receive compensation signal VCOMP and can generate positioning signal V_{VAP} to adjust output voltage V_{OUT}. In this example, adaptation voltage positioning control circuit 32 can utilize pulse-width modulation (PWM) control, pulse frequency adjustment (PFM) control, and/or a combination of the above methods.

In particular embodiments, digital droop voltage Vdrop[n] may be obtained by the product of droop resistor and the digital current sampling signal. The control circuit can filter the current sampling signal that characterizes the inductor current of the switching power supply, in order to generate the low-frequency component of the current sampling signal. The low-frequency component may then be converted by analog-to-digital conversion to generate the digital current sampling signal. In this example, when the switching power supply is a multi-phase power stage circuit connected in parallel, the current sampling signal can characterize the sum of the inductor currents in each power stage circuit. The digital droop resistor may correspond to the output characteristic curve between output voltage V_{OUT} and output current I_{OUT} of the switching power supply. For example, the output characteristic curve can be linear, piecewise linear, or nonlinear.

In particular embodiments, adaptation voltage positioning control circuit 32 can generate positioning signal V_{VAP} based on compensation signal VCOMP, current sampling signal i_{L}, digital voltage reference signal VID[n], and voltage sampling signal VSEN. Different from compensation signal generation circuit 31, adaptation voltage positioning control circuit 32 is an analog control circuit. In one example, the control circuit also can include switch control circuit 33, which may generate switch control signal PWM based on positioning signal V_{VAP} to control the switching states of power switches Q1 and Q2 in power stage circuit 30, in order to achieve regulation of the output voltage.

In particular embodiments, compensation signal generation circuit 31 may form a digital loop to generate compensation signal VCOMP, and adaptive voltage positioning control circuit 32 may form an analog loop to adjust output voltage V_{OUT} according to compensation signal V_{COMP}. The output voltage can be determined by the difference between the analog voltage represented by the digital voltage reference signal VID[n] and the analog voltage of the digital droop voltage. This control method can achieve mixed control of analog and digital by setting two parameters of the reference voltage and the droop resistor, thus avoiding the pain points of full analog or full digital control approaches.

The main body of the control circuit of particular embodiments may adopt an analog current mode architecture. On this basis, a digital loop can be introduced to correct the output voltage, and a rough but fast setting of the output voltage realized by using the fast response of the analog current inner loop. Further, high-precision and slow-speed micro-correction of the output voltage can be realized by using the digital voltage outer loop. Therefore, the control circuit of particular embodiments can address the problem that existing analog schemes are difficult to achieve adjustability across a wide range and high-resolution, and can greatly reduce the requirement for sampling rate in all-digital control, thus ensuring the feasibility and practicality of the design.

In the particular example of FIG. 3, compensation signal generation circuit 31 can include digital integration operation module 311 and digital-to-analog converter (DAC) DAC1. Digital integration operation module 311 can integrate the error between digital voltage reference signal VID[n] and the sum of digital voltage sampling signal V_{SEN[n]} and digital droop voltage Vdrop[n]; that is, to integrate the equation [VID[n]−(V_{SEN[n]}+Vdrop[n])] to generate digital compensation signal V_{COMP[n]} at the output terminal. Digital-to-analog converter DAC1 can convert digital compensation signal V_{COMP[n]} through digital-to-analog conversion to obtain compensation signal V_{COMP}, which may be provided to adaptation voltage positioning control circuit 32 for analog loop control.

In particular embodiments, the digital integration module can include a non-inverting input terminal for receiving a difference between digital voltage reference signal VID[n] and digital droop voltage Vdrop[n], and an inverting input terminal for receiving digital voltage sampling signal V_{SEN[n]}, in order to generate digital compensation signal V_{COMP[n]} at the output terminal, as shown in FIG. 3. In another example, the digital integration module can include a non-inverting input terminal for receiving digital voltage reference signal VID[n], and an inverting input terminal for receiving the sum of digital voltage sampling signal V_{SEN[n]} and the digital droop voltage Vdrop[n], in order to generate digital compensation signal V_{COMP[n]} at the output terminal. Any suitable polarity arrangements for digital integration operation module 311 in performing the operation of the above equation can be supported in certain embodiments. In one example, digital integration operation module 311 can be a digital error amplification circuit, but other digital circuits capable of implementing the above integration operation can also be supported in certain embodiments.

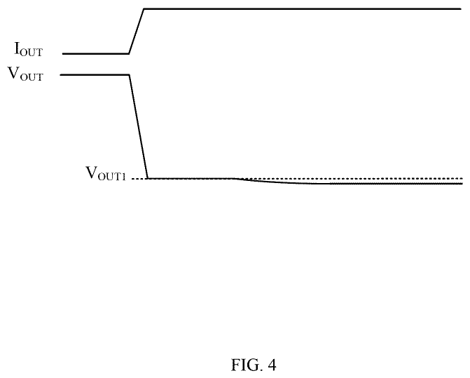

Referring now to FIG. 4, shown is a waveform diagram of the example switching power supply, in accordance with embodiments of the present invention. In this particular example, when output current I_{OUT} is increased, output voltage V_{OUT} can be rapidly reduced to voltage V_{OUT1}, and fine-tuned on the basis of the voltage V_{OUT1}. Thus, the control circuit of particular embodiments can improve the accuracy and resolution of the output voltage.

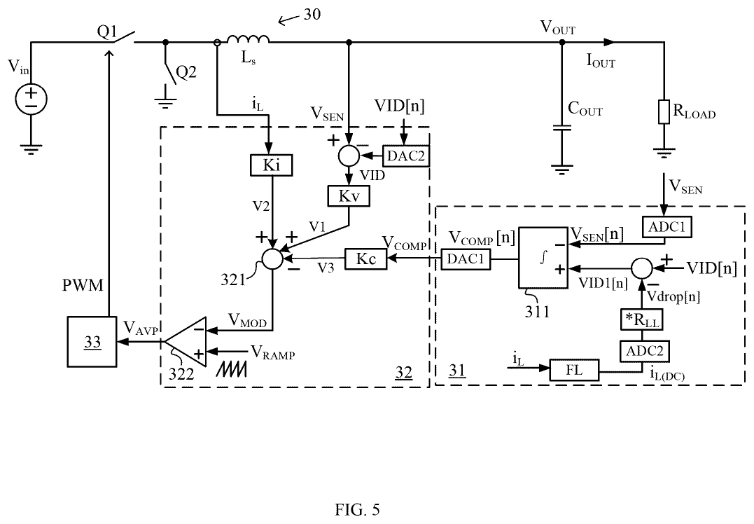

Referring now to FIG. 5, shown is a schematic block diagram of a second example switching power supply with AVP control, in accordance with embodiments of the present invention. In this particular example, compensation signal generation circuit 31 can include analog-to-digital converter (ADC) ADC1, filter circuit FL, analog-to-digital converter ADC2, digital integration operation module 311, and digital-to-analog converter DAC1. Analog-to-digital converter ADC1 can convert voltage sampling signal VSEN, in order to obtain digital voltage sampling signal V_{SEN[n]}. Filtering circuit FL can filter current sampling signal it to generate low-frequency component i_{L(DC)} of the current sampling signal. Analog-to-digital converter ADC2 can convert low-frequency component i_{L(DC)}, to obtain digital current sampling signal i_{L[n]}. Digital integration operation module 311 can generate digital compensation signal V_{COMP[n]} based on digital voltage sampling signal V_{SEN[n]}, digital droop voltage Vdrop[n], and digital voltage reference signal VID[n]. Digital droop voltage Vdrop[n] can be the product of digital current sampling signal i_{L[n]} and digital droop resistor R_{LL}. Digital-to-analog converter DAC1 can obtain compensation signal V_{COMP} after digital-to-analog conversion of digital compensation signal V_{COMP[n]}.

In particular embodiments, digital integration operation module 311 may have an inverting input terminal for receiving digital voltage sampling signal V_{SEN[n]}, and a non-inverting input terminal for receiving digital voltage reference signal VID1[n], and can amplify the error between digital voltage sampling signal V_{SEN[n]} and digital voltage reference signal VID1[n] to generate digital compensation signal V_{COMP[n]}. Digital voltage reference signal VID1[n] can be the difference between digital voltage reference signal VID[n] and digital droop voltage Vdrop[n]; that is, VID1[n]=VID[n]−Vdrop[n]. It should be understood that the error amplification compensation network can use any of the existing technologies (e.g., PI compensation, etc.). In this example, adaptive voltage positioning control circuit 32 can include digital-to-analog converter DAC2, which may obtain analog voltage reference signal VID after digital-to-analog conversion of digital voltage reference signal VID[n].

In particular embodiments, adaptation voltage positioning control circuit 32 can process the difference between voltage sampling signal V_{SEN} and analog voltage reference signal VID through a first gain to obtain a first signal, process current sampling signal i_{L} through a second gain to obtain a second signal, process compensation signal V_{COMP} through a third gain to obtain a third signal, and generate the positioning signal based on the first signal, the second signal, and the third signal. In another embodiment, adaptation voltage positioning control circuit 32 can process voltage sampling signal V_{SEN} through a first gain to obtain a first signal, process current sampling signal it through a second gain to obtain a second signal, process the sum of compensation signal V_{COMP} and analog voltage reference signal VID through a third gain to obtain a third signal, and generate the positioning signal based on the first signal, the second signal, and the third signal.

In particular embodiments, adaptive voltage positioning control circuit 32 also can include superposition circuit 321 and comparison circuit 322. Superposition circuit 321 can superimpose signal V1, signal V2, and the inverted signal of signal V3 to obtain modulation signal V_{MOD}; that is, V_{MOD}=V1+V2−V3=(V_{SEN}−VID)*Kv+i_{L}*Ki−V_{COMP}*Kc. The difference between voltage sampling signal V_{SEN} and analog voltage reference signal VID can be processed by gain Kv to generate signal V1, current sampling signal it may be processed by gain Ki to generate signal V2, and compensation signal V_{COMP} can be processed by gain Kc to generate signal V3. Comparison circuit 322 can compare modulation signal V_{MOD} against ramp signal Vramp to generate positioning signal V_{VAP}.

In particular embodiments, switch control circuit 33 can generate switch control signals for controlling power transistors Q1 and Q2 to be turned on and off, such that the output voltage generated by power stage circuit 30 can confirm the output characteristic curve. The ratio of gain Ki to gain Kv may be determined by the resistance of digital droop resistance R_{LL}. Compensation signal generation circuit 31 may also divide the resistance of digital droop resistor R_{LL} into part R_{LL_1} with the first unit as the unit, and part R_{LL_2} with the second unit as the unit, with the sum of parts R_{LL_1} and R_{LL_2} being the resistance of digital droop resistor R_{LL}. The ratio of gain Ki to gain Kv can be determined by the first part, and the accuracy of compensation signal generation circuit 31 determined by the second part.

The resistance of digital droop resistor R_{LL} may represent the resistance of the virtual droop resistor required by the switching power supply with the AVP control. Digital droop resistor R_{LL} can be a high-resolution value with multiple decimal places. For example, if the target range required for digital droop resistance R_{LL} is 0-3 mΩ and the resolution is as high as 1 uΩ, a total of 3000 adjustable gears can be selected. The specific implementation algorithm may be is described below.

For example, suppose that the resistance of digital droop resistor R_{LL} is 0.42 mΩ. After decomposition, the resistance of digital droop resistor R_{LL} can be divided into part R_{LL_1} with the first unit (e.g., 0.1 m) as the unit and part R_{LL_2} with the second unit (e.g., 1 u) as the unit, where part R_{LL_1} is 4*0.1 mΩ and part R_{LL_2} is 20*0.001 mΩ. When splitting the two parts, a method of direct downward rounding can be adopted. After splitting, the value of the first part can be completed by the analog current inner loop; that is, adaptive voltage positioning control circuit 32. For example, gain Ki and gain Kv can meet the following formula: Ki/Kv=R_{LL_1}=0.4 m. The value of the second part can be regulated by the digital voltage outer loop, which may be completed by adaptive voltage positioning control circuit 1.

In particular embodiments, when dealing with the splitting of digital droop resistor R_{LL}, the principle of large number processing with downward rounding can be adopted. Other large number processing principles (e.g., rounding, etc.) can also be supported in certain embodiments. Due to differences in response speed between the analog inner loop and the digital outer loop, the load dynamic response process of the output voltage can be roughly divided into a part dominated by the analog inner loop, which is fast but inaccurate, and another part dominated by the digital outer loop, which is slow but accurate. Particular embodiments may provide a digital-analog hybrid control scheme that combines the advantages of analog and digital control and avoids their respective shortcomings. The main body of the control loop of particular embodiments may adopt an analog current mode architecture, and as such a digital loop containing an ADC and a DAC can be introduced to correct the output voltage.

Particular embodiments may provide a control circuit for a switching power supply with AVP control. The fast response of the analog current inner loop can realize the adjustment of the output voltage with a rough but fast setting. The range of the digital droop resistor can be increased and the number of gears reduced. The high resolution of the ADC in the digital voltage outer loop can realize the high precision and relatively small correction of the output voltage. The reference voltage can be calculated and the integral operation may be performed to generate the control signal in the digital voltage outer loop. The DAC can convert the control signal into an analog signal, and inject it into the comparator of the analog current inner loop to adjust the droop output characteristics of the output voltage. Therefore, the control circuit can address the problem that existing simulation schemes have difficulty in achieving wide range and high resolution adjustability for the output voltage, can greatly reduce the requirement of a high-speed sampling rate of the ADC in full digital control, and may ensure feasibility and practicability design.

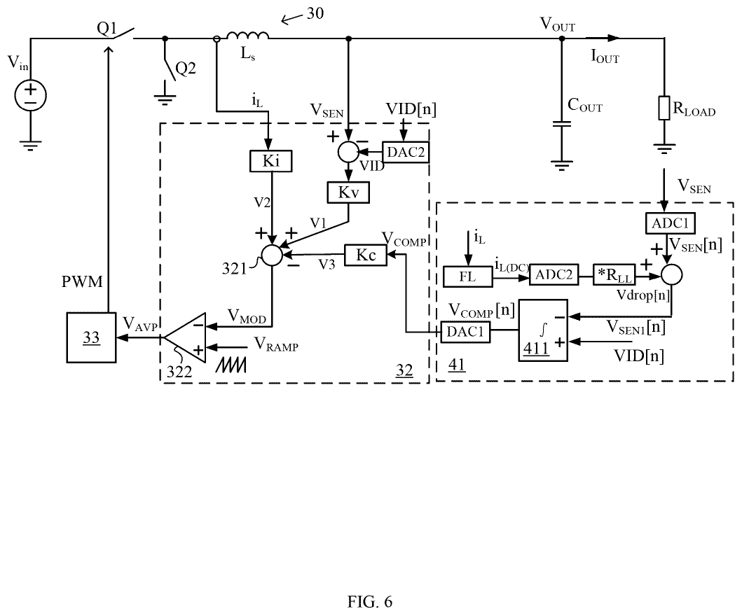

Referring now to FIG. 6, shown is a schematic block diagram of a third example switching power supply with AVP control, in accordance with embodiments of the present invention. In this particular example, compensation signal generation circuit 41 can superimpose digital droop voltage Vdrop[n] on digital voltage sampling signal V_{SEN[n]} to generate digital voltage reference signal VID1[n], and generate compensation signal V_{COMP} based on an error between digital voltage reference signal VID1[n] and digital voltage reference signal VID[n]. For example, compensation signal generation circuit 41 can include digital integration operation module 411. Digital integration operation module 411 may have an inverting input terminal for receiving digital voltage sampling signal V_{SEN1[n]}, and a non-inverting input terminal for receiving digital voltage reference signal VID[n], and can amplify the error between digital voltage sampling signal V_{SEN1[n]} and digital voltage reference signal VID[n] to generate digital compensation signal V_{COMP[n]}. For example, digital voltage sampling signal V_{SEN1[n]} is the sum of digital voltage sampling signal V_{SEN[n]} and digital droop voltage Vdrop[n].

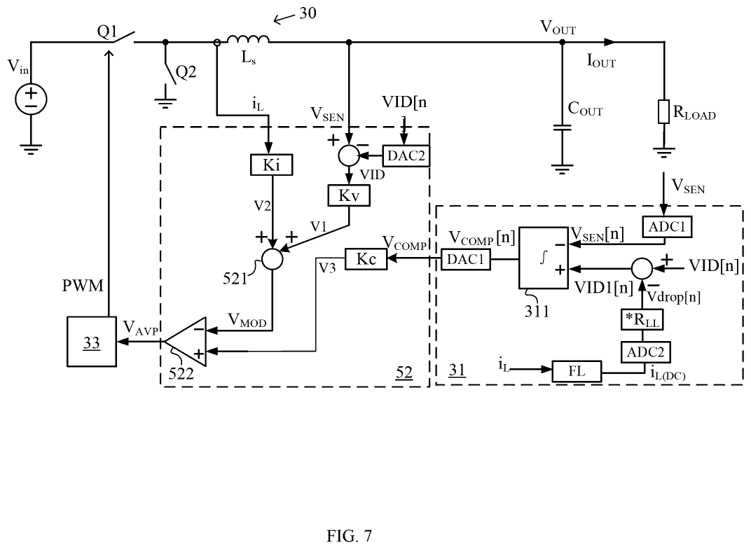

Referring now to FIG. 7, shown is a schematic block diagram of a fourth example switching power supply with AVP control, in accordance with embodiments of the present invention. Here, the transmission mode of the signal in adaptive voltage positioning control circuit 52 is different than the examples above. In this particular example, adaptive voltage positioning control circuit 52 can include digital-to-analog converter DAC2, superposition circuit 521, and comparison circuit 522. Digital-to-analog converter DAC2 can obtain analog voltage reference signal VID after digital-to-analog conversion of digital voltage reference signal VID[n]. Superimposed circuit 521 can superimpose signals V1 and V2 to obtain modulation signal V_{MOD}. Here, the difference between voltage sampling signal V_{SEN} and analog voltage reference signal VID can be processed by gain Kv to generate signal V1, and current sampling signal i_{L} may be processed by gain Ki to generate signal V2, that is, V_{MOD}=V1+V2=(V_{SEN}−VID)*Kv+iL*Ki. Comparison circuit 522 can compare modulation signal V_{MOD} against signal V3 to generate positioning signal V_{VAP}, and compensation signal V_{COMP} can be processed by gain Kc to generate signal V3.

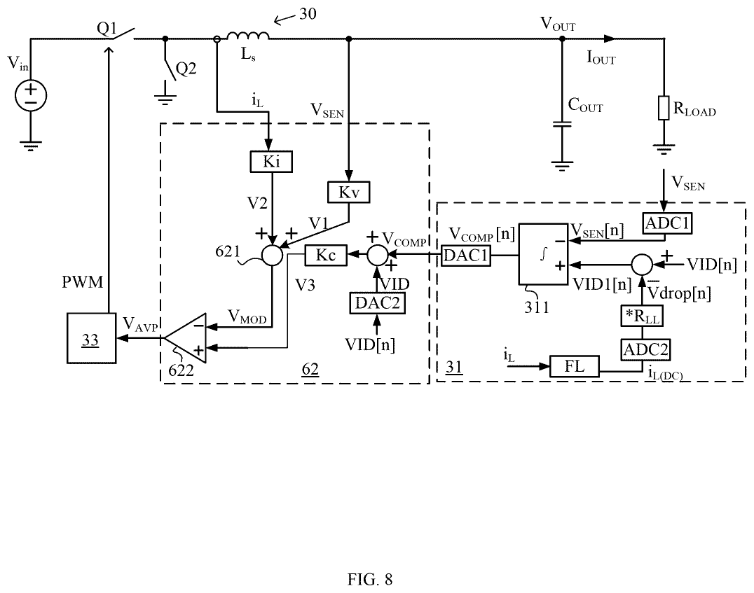

Referring now to FIG. 8, shown is a schematic block diagram of a fifth example switching power supply with AVP control, in accordance with embodiments of the present invention. Here, the transmission mode of the signal in adaptive voltage positioning control circuit 62 is different than the examples above. In this particular example, voltage positioning control circuit 62 can include digital-to-analog converter DAC2, superposition circuit 621, and comparison circuit 622. Digital-to-analog converter DAC2 can obtain analog voltage reference signal VID after digital-to-analog conversion of digital voltage reference signal VID[n]. Superposition circuit 621 can superimpose signal V1 and signal V2 to obtain modulation signal V_{MOD}. Here, voltage sampling signal V_{SEN} can be processed by gain Kv to generate signal V1, and current sampling signal it may be processed by gain Ki to generate signal V2; that is, V_{MOD}=V1+V2=V_{SEN}*Kv+iL*Ki. Comparison circuit 622 can compare signal V3 against modulation signal V_{MOD} to generate positioning signal V_{VAP}. The sum of compensation signal Vcomp and analog voltage reference signal VID can be processed by gain Kc to generate signal V3; that is, V3=(V_{COMP}+VID)*KC.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A control circuit for a switching power supply with adaptive voltage positioning control, the control circuit comprising:
a) a compensation signal generation circuit configured to receive a digital voltage reference signal, a digital voltage sampling signal representing an output voltage of the switching power supply, and a digital droop voltage, and to integrate an error between the digital voltage reference signal and a sum of the digital voltage sampling signal and the digital droop voltage, in order to generate a compensation signal; and
b) an adaptive voltage positioning control circuit configured to generate a positioning signal according to the compensation signal, in order to adjust the output voltage.

2. The control circuit of claim 1, wherein the digital droop voltage is generated by multiplying a digital droop resistor and a digital current sampling signal, and the digital current sampling signal is obtained by filtering a current sampling signal characterizing an inductor current of the switching power supply and then passing through analog-to-digital conversion.

3. The control circuit of claim 2, wherein the digital droop resistor corresponds to an output characteristic curve of the output voltage and the output current.

4. The control circuit of claim 1, wherein the compensation signal generation circuit comprises:
a) a digital integration operation module configured to integrate the error between the digital voltage reference signal and the sum of the digital voltage sampling signal and the digital droop voltage, in order to generate a digital compensation signal at an output terminal; and
b) a first digital-to-analog converter configured to convert the digital compensation signal to obtain the compensation signal.

5. The control circuit of claim 4, wherein the digital integration operation module comprises a non-inverting input terminal for receiving a difference between the digital voltage reference signal and the digital droop voltage, and an inverting input terminal for receiving the digital voltage sampling signal, in order to generate the digital compensation signal at the output terminal.

6. The control circuit of claim 4, wherein the digital integration operation module comprises a non-inverting input terminal for receiving the digital voltage reference signal, and an inverting input terminal for receiving the sum of the digital voltage sampling signal and the digital droop voltage, in order to generate the digital compensation signal at the output terminal.

7. The control circuit of claim 1, wherein the adaptive voltage positioning control circuit is configured generate the positioning signal according to a voltage sampling signal characterizing the output voltage of the switching power supply, a current sampling signal characterizing the inductor current, the digital voltage reference signal, and the compensation signal.

8. The control circuit of claim 4, wherein the compensation signal generation circuit comprises:
a) a first analog-to-digital converter configured to perform an analog-to-digital conversion of the voltage sampling signal to obtain the digital voltage sampling signal;
b) a low pass filter configured to filter a current sampling signal characterizing an inductor current of the switching power supply; and
c) a second analog-to-digital converter configured to perform an analog-to-digital conversion of the filtered current sampling signal to obtain the digital current sampling signal.

9. The control circuit of claim 4, wherein the digital integration operation module is configured as a digital error amplification circuit.

10. The control circuit of claim 1, wherein the adaptive voltage positioning control circuit comprises:
a) a second digital-to-analog converter configured to perform an analog-to-digital conversion of the digital voltage reference signal, in order to obtain an analog voltage reference signal; and
b) wherein the adaptive voltage positioning control circuit is configured to process a difference between a voltage sampling signal representing the output voltage and the analog voltage reference signal through a first gain to obtain a first signal, to process a current sampling signal representing an output current through a second gain to obtain a second signal, and to process the compensation signal through a third gain to obtain a third signal, in order to generate the positioning signal based on the first signal, the second signal, and the third signal.

11. The control circuit of claim 1, wherein the adaptive voltage positioning control circuit comprises:
a) a second digital-to-analog converter configured to perform an analog-to-digital conversion of the digital voltage reference signal, in order to obtain an analog voltage reference signal; and
b) wherein the adaptive voltage positioning control circuit is configured to process a voltage sampling signal representing the output voltage through a first gain to obtain a first signal, to process a current sampling signal representing an output current through a second gain to obtain a second signal, and to process a sum of the compensation signal and the analog voltage reference signal through a third gain to obtain a third signal, in order to generate the positioning signal based on the first signal, the second signal, and the third signal.

12. The control circuit of claim 10, wherein the adaptive voltage positioning control circuit comprises:
a) a superposition circuit configured to superimpose the first signal, the second signal, and an inverted signal of the third signal, in order to generate a modulated signal; and
b) a comparison circuit configured to compare the modulation signal against a slope signal, in order to generate the positioning signal.

13. The control circuit of claim 10, wherein the adaptive voltage positioning control circuit comprises:
a) a superposition circuit configured to superimpose the first signal on the second signal, in order to generate a modulated signal; and
b) a comparison circuit configured to compare the modulation signal against the third signal, in order to generate the positioning signal.

14. The control circuit of claim 10, wherein a ratio of the second gain to the first gain is determined by a first part of the resistance of the digital droop resistor.

15. The control circuit of claim 11, wherein the adaptive voltage positioning control circuit comprises:
a) a superposition circuit configured to superimpose the first signal on the second signal, in order to generate a modulated signal; and
b) a comparison circuit configured to compare the modulation signal against the third signal, in order to generate the positioning signal.

16. The control circuit of claim 11, wherein a ratio of the second gain to the first gain is determined by a first part of the resistance of the digital droop resistor.

17. The control circuit of claim 2, wherein a resistance of the digital droop resistor is divided into a first part with a first unit as a unit, and a second part with a second unit as a unit, and the sum of the first part and the second part is the resistance of the digital droop resistor.

18. The control circuit of claim 16, wherein an accuracy of the compensation signal generation circuit is determined by the second part.

19. The control circuit of claim 1, further comprising a switch control circuit configured to generate a switch control signal according to the positioning signal, in order to control the switching state of a power switch in the switching power supply.

20. A switching power supply, comprising the control circuit of claim 1, and further comprising a power stage circuit.
